(19) United States
(12) Patent Application Publication
(10) Pub. No.: US 2010/0004918 A1
(43) Pub. Date: Jan. 7, 2010

(54) LANGUAGE TRANSLATOR HAVING AN AUTOMATIC INPUT/OUTPUT INTERFACE AND METHOD OF USING SAME

(75) Inventors: Yujeong Lee, Seoul (KR); Jeongsik Jang, Gyeonggi-do (KR)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/174,202

(22) Filed: Jul. 16, 2008

(30) Foreign Application Priority Data
Jul. 4, 2008 (KR) 10-2008-64943

(51) Int. Cl. G06F 17/28

(52) U.S. Cl. 704/3

(57) ABSTRACT

The present disclosure provides a language translator having an automatic input/output interface and a method of interfacing the same. In certain embodiments, the language translator comprises a text input unit, a translation engine, a working environment determining unit and an output unit. The text input unit is configured to receive a first text in a first language. The translation engine is configured to translate the first text into a second text in a second language. The working environment determining unit is configured to determine a current working environment. The output unit is configured to output the second text in the current working environment. The user does not need to type or copy-and-paste the translation result in the working environment, thereby improving the convenience of using the language translator.

### BACKGROUND OF THE INVENTION

The present disclosure relates to a language translator. More specifically, the present disclosure relates to a language translator having an automatic input/output interface.

The advent of language translators has eliminated the need to refer to dictionaries in order to find the meaning of an unknown word or text in a foreign language. Language translators, which are currently in common use, may often be incorporated in computer systems, mobile devices, electronic dictionaries, etc., or provided as an online service, e.g., via web sites. Examples of conventional language translators include Google Translator Interface Platinum provided by Google®, BABELFISH provided by Yahoo! Inc, etc.

A conventional language translator generally requires a user's manual input of words or sentences to its input interface for its translation operation. That is, the user has to type words or sentences for translation in the input interface of the translator or otherwise copy-and-paste them from the document in which he or she is working. The user typically also bears the burden of copying-and-pasting the translated words or sentences from the output interface of the translator back to his or her preferred working environment, e.g., applications of interest, such as a word processor, an Internet chat program, an instant messenger, or an Internet web browser.

The series of manual operations mentioned above tend to be quite annoying and time-consuming to the user.

### SUMMARY OF THE INVENTION

The present disclosure provides methods and apparatus for performing text translation. According to various embodiments, text in a first language is received via a translation interface on a device; a current working environment on the device separate from the translation interface is determined; and a translation of the text in a second language is provided from the translation interface to the current working environment.

In one embodiment, determining a current working environment involves receiving a user's selection of one of a plurality of currently active working environments.

In one embodiment, determining a current working environment involves determining a current working environment based on a working history list including currently and previously active working environments.

In one embodiment, receiving a text in a first language involves placing a transparent portion of the translation interface over the text.

In addition to providing a translation of the text in a second language in the current working environment, specific embodiments of the invention also include providing the translation of the text in an output interface window of the language translator or providing the translation of the text in voice using a TTS function.

A further understanding of the nature and advantages of the present invention may be realized by reference to the remaining portions of the specification and the drawings.

### BRIEF DESCRIPTION OF THE DRAWINGS

FIG. 1 is a block diagram showing a configuration of a language translator in one embodiment.

FIG. 2 is a flow chart showing a translation process based on a translator interface in one embodiment.

FIG. 3 shows an example of a translator interface in one embodiment.

FIG. 4 shows an example of a translator interface having a transparent input interface window in one embodiment.

FIG. 5 illustrates an exemplary placement of a transparent input interface window onto an input application in one embodiment.

FIG. 6A illustrates a list of currently active applications for selection by a user in one embodiment.

FIG. 6B illustrates a list of currently active applications as a drop down menu displayed on a translator interface in one embodiment.

FIG. 7 shows a transparent input interface window placed onto an input application together with an output application having a translation result in its designated location in one embodiment.

FIG. 8 is a simplified diagram of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the present invention may be implemented in a wide variety of computing environments. Such environments may include, but are not limited to, a personal computer, a server, a mobile computing device, etc. Embodiments of the present invention may also be implemented with a wide variety of computer-executable instructions in a variety of languages and according to a wide range of computing models. Such computer-executable instructions may include, but are not limited to, programs, modules, ActiveX or scripts executable on the operating systems of a computer system such as Windows®, Unix or Linux. Computer-executable instructions may be stored in one or more computer-readable medium such as a memory, a disk drive, CD-ROM, DVD, or diskette. In addition, computer-executable instructions may reside in one or more remote computer systems and may be executed over a network.

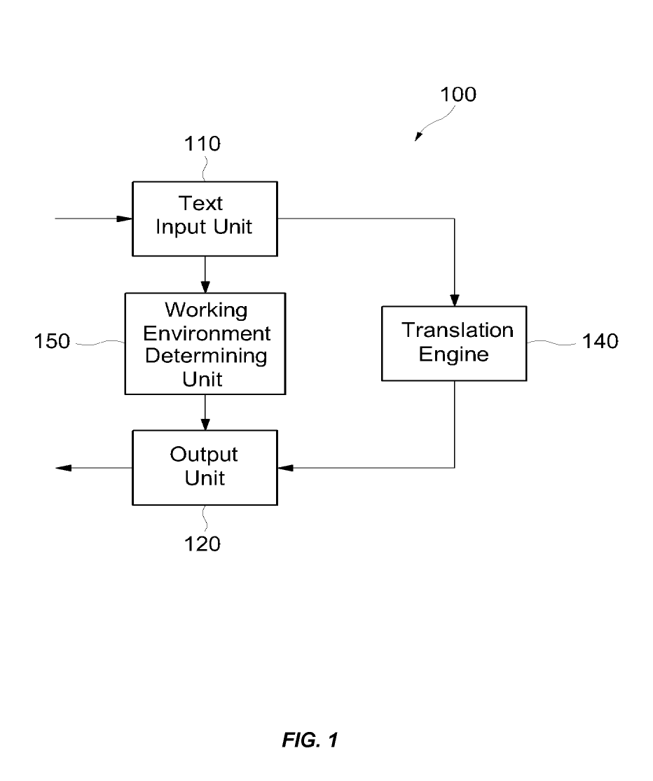

FIG. 1 is a block diagram showing a configuration of a language translator in one embodiment. The language translator 100 may include a text input unit 110 configured to receive text, i.e., words or sentences to be translated, from a user. In one embodiment, the text input unit 110 may include input devices such as a keyboard, a touch screen, a touch pen, a mouse, or the like. In one embodiment, the text input unit 110 may be implemented to provide a text input interface window of the language translator.

In one embodiment, the text input unit 110 may alternatively or additionally be configured to provide a transparent input interface window, which may be placed upon an application program in a transparent manner and configured to capture text thereon. In response to the typing on the window of the text or placement of the window upon the same, the transparent input interface window may capture and recognize the typed or placed text. In one embodiment, the transparent input interface window may include a character recognition program module that may be operable to recognize a portion of an image file (e.g., PDF file) as text.

In one embodiment, the language translator 100 may further include a language selection unit (not shown), which may be configured to receive information on a target language into which the text is translated. In one embodiment, the language selection unit may be implemented into a list control window or the like. A user can then select one of the available languages from the list.

As shown in FIG. 1, the language translator 100 may further include a translation engine 140 coupled to the text input unit 110. The translation engine 140 may translate the text in a certain language (hereinafter, “the first language”) into the target language (hereinafter, “the second language”). In one embodiment, the translation engine 140 may translate the text in the first language into the second language, which has been selected in the language selection unit as described above. In one embodiment, the translation engine 140 may reside in an external device or an external server in communication with the language translator 100. The translation engine 140 may be implemented using any of a wide variety of known translation engines or applications or any translation engine or application to be developed in the future. Thus, further details on the translation engine are omitted herein.

The language translator 100 may further include a working environment determining unit 150 in communication with the text input unit 110. In response to the text being inputted in the text input unit 110, the working environment determining unit 150 may determine the user's current working environment. According to various embodiments, the working environment determining unit 150 may determine the user's current working environment by receiving a user's selection of one of the working environments that are being currently executed, or may automatically determine the current working environment without receiving the user's information.

Embodiments in which the working environment determining unit 150 receives the user's selection will be discussed first. With the help of the operating system (e.g., WINDOWS®) on which the language translator 100 is running, the working environment determining unit 150 may display a list of the working environments being executed (e.g., application programs), for example, using a list control window or the like with which the user may make a selection. Alternatively, the working environment determining unit 150 may determine the application that the user activates while the language translator 100 is operating or after the completion of the translation by the translation engine 140 as the user's current working environment. For example, when a new instant messaging environment is executed or a background instant messaging environment is activated by the user after the completion of translation, the working environment determining unit 150 may determine the instant messaging environment as the user's current working environment.

Embodiments in which the working environment determining unit 150 automatically determines the user's current working environment will now be discussed. With the help of the operating system on which the language translator 100 is running, the working environment determining unit 150 may acquire the user's working history and may determine the user's current working environment based on the obtained history. For example, the working environment determining unit 150 may determine the last application that the user has worked with or the application that the user has worked with just before activating the language translator 100.

In one embodiment, the working environment determining unit 150 may transfer information on the application determined as the user's current working environment to an output unit 120 for its display by means of an icon or text or other suitable indicator. In this way, the user can check which working environment is determined as the current working environment. The working environment determining unit 150 may change the current working environment in response to the user's activation of another working environment.

The language translator 100 may further include an output unit 120 in communication with the translation engine 140 and the working environment determining unit 150. The output unit 120 may receive the translated text from the translation engine 140 and may receive information about the current working environment in order to provide the translated text onto the current working environment. For example, if the information from the working environment determining unit 150 indicates that an instant messaging application corresponds to the current working environment, then the output unit 120 may output or copy-and-paste the translated text at the location of the cursor of the instant messaging application directly. Alternatively, the output unit 120 may display the translated text in a separate output interface window.

As mentioned above, the output unit 120 may display the information on current working environment by means of an icon or text. In such a case, the output unit 120 may also provide a working environment display interface window.

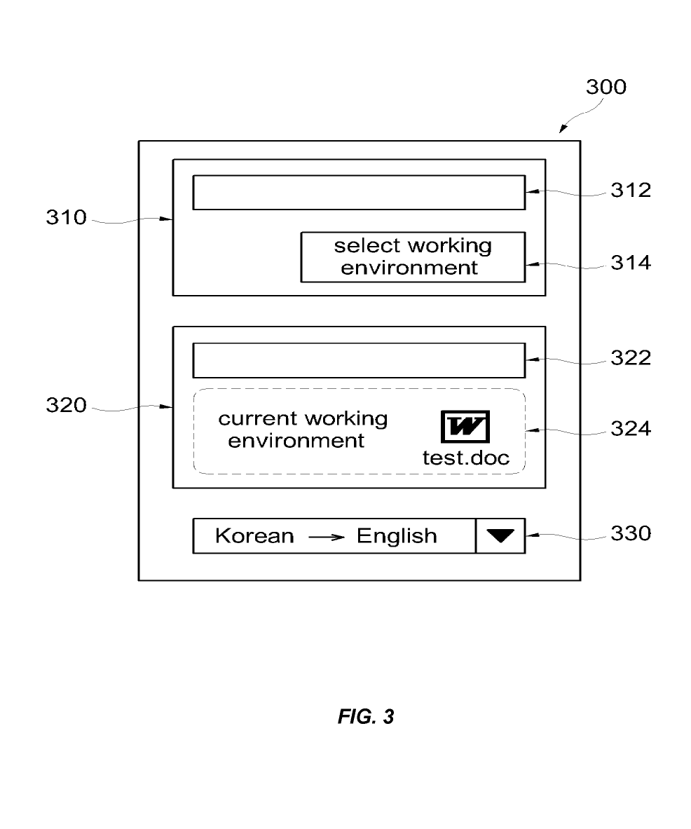

FIG. 3 shows an example of a translator interface in one embodiment. As shown in FIG. 3, a translator interface 300 includes an input interface 310 and an output interface 320. The input interface 310 may include a text input interface window 312 and may optionally include a working environment input interface window 314. The output interface may include a text output interface window 322 and a working environment display interface window 324. The translator interface 300 may optionally include a language selection interface 330. The language selection interface 330 may display the languages available for selection as the first language and the second language in the form of, for example, a menu or list. The user may select the desired first and second languages from the menu or list.

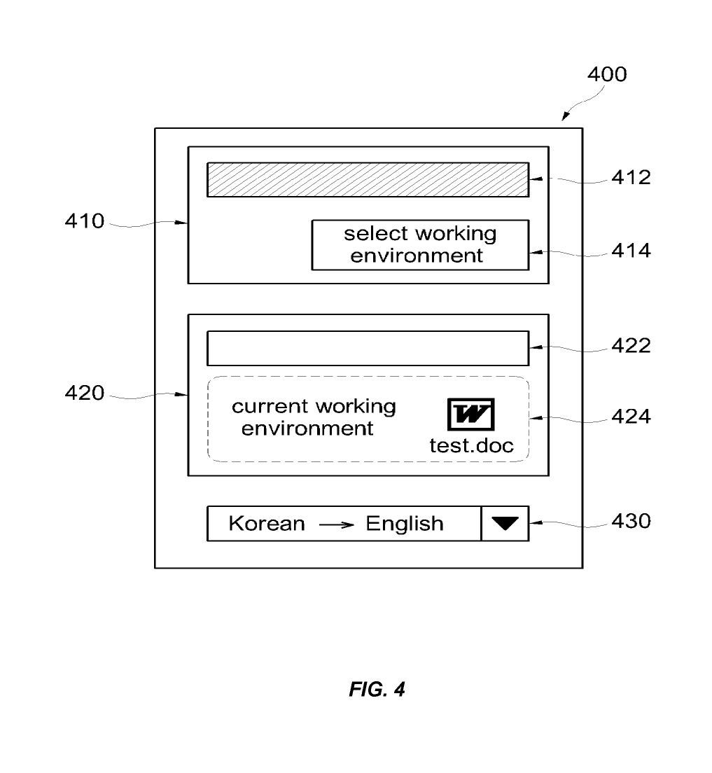

FIG. 4 shows an example of a translator interface having a transparent input interface window in one embodiment. The translator interface 400 comprises a transparent input interface window 412. The remaining interfaces 414, 422, 424 and 430 are similar to the corresponding ones of the translator interface 300.

With the aforementioned working environment determining unit 150, a translation result may be automatically provided onto the user's current working environment. Thus, the user does not need to make additional efforts to copy-and-paste the translation result, which may improve the user's experience. Since the user can change or specify the current working environment onto which the translation result should be provided, the user may utilize the translation result in various applications. As mentioned above, the text to be translated may be captured using a transparent input interface. Thus, the user does not need to manually type the text to be translated in the text input interface. Furthermore, the translation result may be provided directly onto the application, which further improves the user's experience.

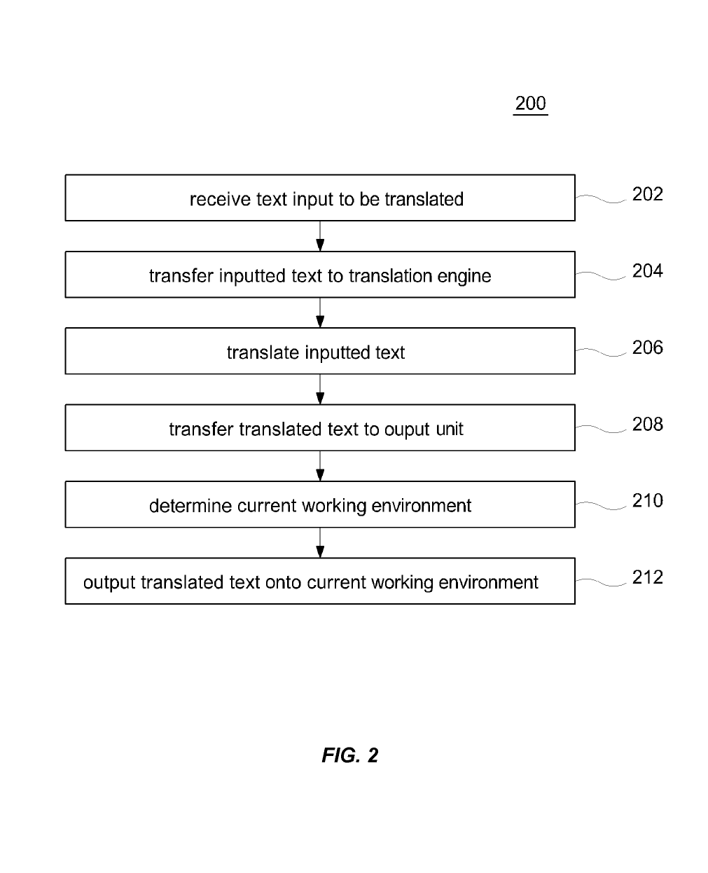

FIG. 2 is a flow chart showing a translation process using a language translator (e.g., language translator 100) according to one embodiment. At step 202, first text to be translated is inputted into the text input unit 110. In one embodiment, the user may input the text into the text input interface window 312 of the translator interface 300.

In one embodiment, the user may place a transparent text input interface window upon the text to be translated in a transparent manner using the transparent text input interface window of the translator interface 400 which may be movable upon the user's manipulation. Alternatively, the transparent text input interface window may be placed on the text to be translated automatically.

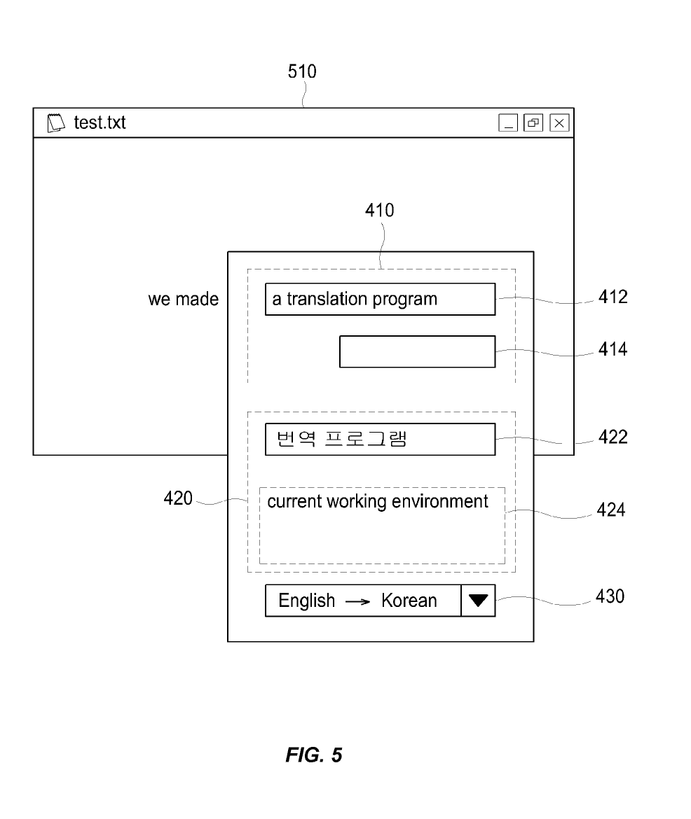

FIG. 5 illustrates an exemplary placement of a transparent input interface window onto an input application in one embodiment. Referring to FIG. 5, the user may move the translator interface 400 onto the user's working environment 510 to place the text input interface window 412 upon the words or sentences to be translated (e.g., the words “translation program” in FIG. 5). Since the text input interface window 412 is transparent, the user may see the text in the working environment through the text input interface 412. As such, the user can get the same result as typing words or sentences into the text input interface only by placing the transparent text input interface 412 of the translator interface 400. As a result, the user can save additional efforts to manually input or copy-and-paste words or sentences to be translated.

Although FIG. 5 illustrates the operation to place the transparent text input interface upon the text in the working environment 510, it should be appreciated that it may be still possible to directly input words or sentences into the transparent text input interface window 412.

In one embodiment, when words or sentences are located in the transparent text input interface window 412, the language translator may perform translation of the words or sentences immediately. Alternatively, when words or sentences are located in the transparent text input interface 412, translation may be initiated in response to the user's predetermined action (e.g., clicking a button).

In one embodiment, when a part of a word or sentence is located in the text input interface 412, the language translator 100 may translate only that part of the word or sentence. Alternatively, when a part of a word or sentence is located in the text input interface 412, the language translator 100 may automatically detect and translate the entire word or sentence which includes the part of the word or sentences located in the text input interface 412.

In one embodiment, the input interface 410 and the output interface 420 can be separated. In this embodiment, the user may move and place only the input interface 410 upon the words or sentences to be translated. Alternatively, the user may separate the text input interface window 412 from the input interface 410 and place it upon the words or sentences to be translated.

In one embodiment, the user may resize the text input interface 412 so that it may fit all or a larger portion of the text to be translated.

Referring back to FIG. 2, at step 204, the inputted first text is transferred to the translation engine 140. The translation engine 140 translates the first text into second text in the predetermined language or the language selected from the language selection interface 330 at step 206. Then, the translation engine 140 transfers the second text to the output unit 120 at step 208.

The working environment determining unit 150 determines the user's current working environment at step 210. The user may input the information on the current working environment using the working environment input interface window 314. For example, when the user clicks the working environment input interface window 314 of the translator interface 300, the working environment input interface window may display the list of the applications being currently executed on the operating system. The user may select the target working environment from the list where the translation result will be provided.

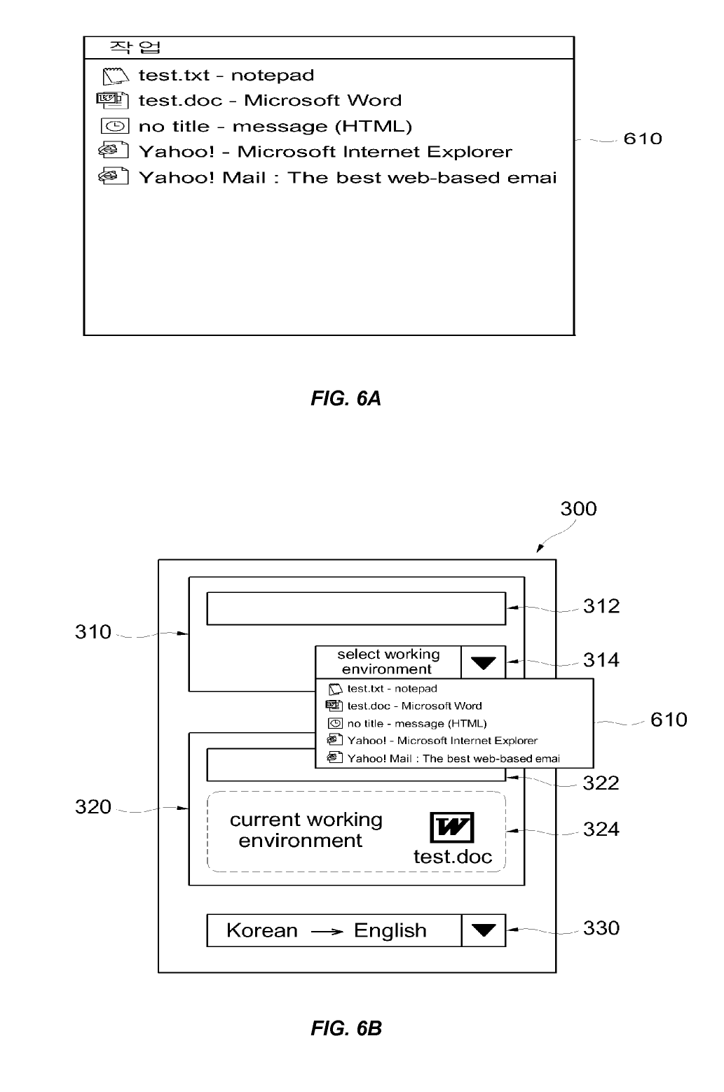

FIG. 6A illustrates a list of currently active applications for selection by a user in one embodiment. However, the present invention is not limited to these applications or the specific manner in which they are displayed. For example, it is also possible to display the list of applications in other forms such as icons. FIG. 6B illustrates a list of currently active applications as a drop down menu displayed on a translator interface 300 in one embodiment.

In one embodiment, the language translator may automatically detect the user's current working environment. For example, the working environment determining unit 150 may determine the application that the user has used most recently as the user's current working environment based on the user's working history. For example, if the user activates the language translator while the user performs writing operations in an input window of an instant messaging application, the working environment determining unit 150 of the language translator 100 may automatically determine the instant messaging application as the user's current working environment. As such, the language translator may determine the user's current working environment based on the user's working history or other criteria.

In one embodiment, as shown in FIG. 3, the language translator may display the icon or the name of application corresponding to the user's current working environment in the working environment display interface window 324. This is so that the user may be aware of which application has been determined as the current working environment.

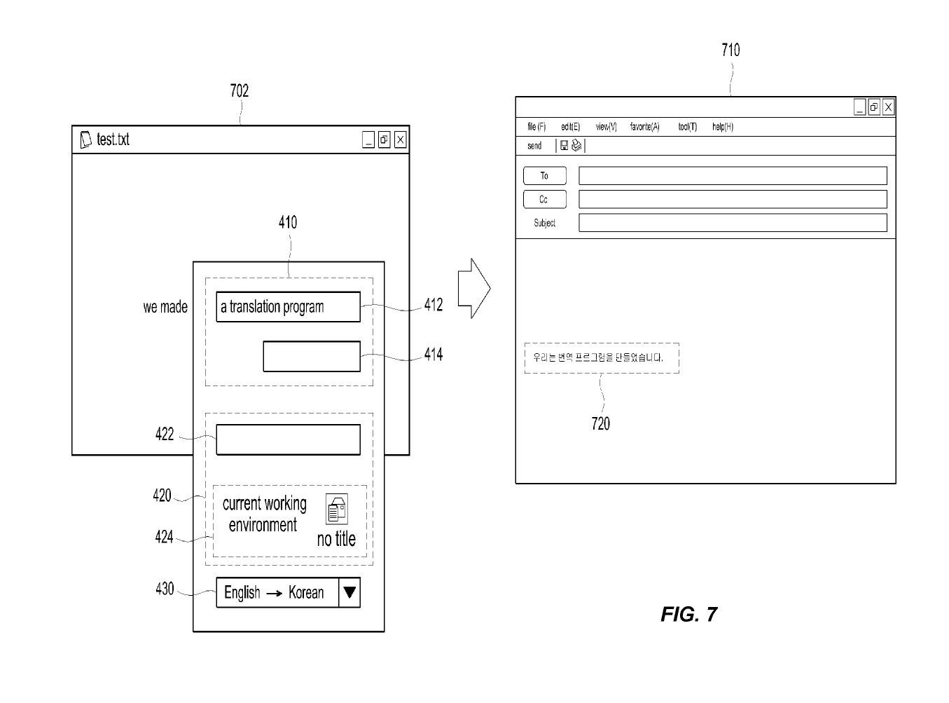

At step 212, the output unit 120 provides the translated text onto the determined working environment. For example, assume that the third item of the working environment list 610 (i.e., e-mail editor) is selected as the current working environment by the user at step 210. FIG. 7 shows a transparent input interface window placed onto an input application together with an output application having a translation result in its designated location in one embodiment. In the embodiment shown in FIG. 7, the language translator 100 may detect the entire sentence in the notepad 702 that includes the text being overlapped by the transparent input interface window 412 (i.e., “We made translation program”) and may receive it as an input. Then, the language translator outputs the translated text 720 onto the e-mail editor 710. In one embodiment, the translated text 720 may be inserted at the location of the cursor of the current working environment. Alternatively, the translated text 720 may be added to the end of the text in the current working environment.

The translated text may be displayed in the text output interface window 422 of the translator interface 400. In one embodiment, the user may check the result of translation displayed in the text output interface window 422 and allow the result be provided onto the current working environment by the user's manipulation if the user so desires.

In one embodiment, the translation result may be outputted in response to a predetermined action. For example, when the user inputs text to be translated, then the translation of the text may be reserved until the user clicks or activates a certain application window. When the user clicks a certain application, the working environment determining unit 150 may determine the clicked application as the current working environment. For example, when the user inputs text to be translated, the translator may not output the translation result immediately. Then, when the user clicks or activates a certain application window such as an instant messaging application, the language translator may determine the clicked application as the current working environment and may provide the translated text onto the clicked application.

Although a particular method of providing an input/output interface of a language translator has been discussed with reference to FIG. 2, the present invention is not limited to the described embodiment. For example, embodiments of the invention may be implemented in a different order from FIG. 2. For example, step 210 in which the working environment determining unit 150 determines the current working environment may be performed at any position before step 212 in which the output unit 120 outputs the translated text.

As described above, by outputting the translation result directly to the determined working environment, the user does not need to make additional efforts to copy-and-paste the translation result.

In one embodiment, the language translator may include TTS (Text to Speech) functionality to output the translated text in voice. When the user types text to be translated manually or selects text to be translated using, for example, the transparent input interface 412, the translated text may be converted into voice by the TTS module and may then be outputted by the output unit.

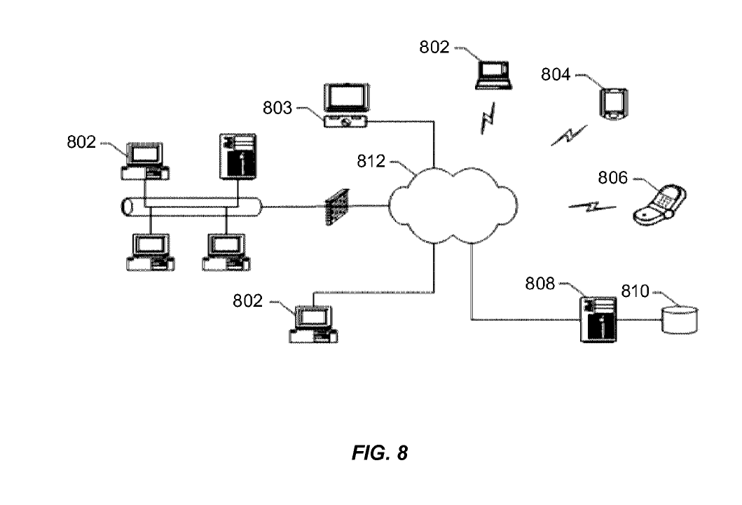

Embodiments of the invention may be employed to facilitate language translation in any of a wide variety of computing contexts. For example, as illustrated in FIG. 8, implementations are contemplated in which the relevant population of users interacts with a diverse network environment via any type of computer (e.g., desktop, laptop, tablet, etc.) 802, media computing platforms 803 (e.g., cable and satellite set top boxes and digital video recorders), handheld computing devices (e.g., PDAs, email clients, etc.) 804, cell phones 806, or any other type of computing or communication platform.

As will be understood, various processes and services enabled by embodiments of the invention may be provided in a centralized manner. This is represented in FIG. 8 by server 808 and data store 810 which, as will be understood, may correspond to multiple distributed devices and data stores. Language translation services may then be provided to the users in the network via various channels with which the users interact with the network.

Various aspects of the invention may also be practiced in a wide variety of network environments (represented by network 812) including, for example, TCP/IP-based networks, telecommunications networks, wireless networks, etc. In addition, the computer program instructions and data structures with which embodiments of the invention are implemented may be stored in any type of computer-readable media, and may be executed according to a variety of computing models including, for example, a client/server model, a peer-to-peer model, on a stand-alone computing device, or according to a distributed computing model in which various functionalities described herein may be effected or employed at different locations.

According to the various embodiments of the invention, at least some of the following effects, benefits, and/or advantages may be realized.

First, in accordance with specific embodiments, since a translation result can be outputted to the user's working environment directly, additional operations such as copy and paste may not be required.

Second, in accordance with some embodiments, the user may be enabled to specify or change the current working environment to which the translation result would be outputted.

Third, in accordance with other embodiments, the translator may automatically determine the current working environment, which may reduce the user's input operations.

Fourth, since the user can input text using a transparent input interface according to some embodiments, the user may not be required to manually type the text.

Fifth, since the translation result can be outputted to the application program, user experience may be improved.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method of performing text translation, comprising:
receiving text in a first language via a translation interface on a device;
determining a current working environment on the device separate from the translation interface; and
providing a translation of the text in a second language from the translation interface to the current working environment.

2. The method of claim 1, wherein determining the current working environment comprises receiving a user's selection of one of a plurality of currently active working environments.

3. The method of claim 1, wherein determining the current working environment comprises determining a current working environment based on a working history list including currently and previously active working environments.

4. The method of claim 3, wherein determining the current working environment comprises selecting a most recent working environment from the currently active working environments in the working history list.

5. The method of claim 1, wherein receiving the text in the first language comprises placing a transparent portion of the translation interface over the text.

6. The method of claim 2, wherein receiving the user's selection of one of the currently active working environments comprises detecting the user clicking said one of the currently active working environments, and wherein the translation of the text in the second language is provided to the current working environment in response to said detection.

7. A language translator having an input/output interface, comprising,
a text input unit configured to receive first text in a first language via a translation interface on a device;
a translation engine configured to translate the first text into second text in a second language;
a working environment determining unit configured to determine a current working environment on the device separate from the translation interface; and
an output unit configured to provide the second text from the translation interface to the current working environment.

8. The translator apparatus as recited in claim 7, wherein the working environment determining unit determines the current working environment by a user's selection of one of a plurality of currently active working environments.

9. The translator apparatus as recited in claim 7, wherein the working environment determining unit determines the current working environment based on a working history list including currently and previously active working environments.

10. The translator apparatus as recited in claim 9, wherein the working environment determining unit determines a most recent working environment from the currently active working environments in the working history list as the current working environment.

11. The translator apparatus as recited in claim 7, wherein a portion of the translation interface comprises a transparent input interface, and wherein the text input unit is further configured to receive the first text in the first language in response to the transparent input interface being placed over the first text.

12. A computer program product comprising at least one computer-readable medium for storing computer-executable instructions, the computer-executable instructions being configured to perform the following steps when executed by a processor:
receiving text in a first language via a translation interface on a device;
determining a current working environment on the device separate from the translation interface; and
providing a translation of the text in a second language from the translation interface to the current working environment.

13. The computer program product of claim 12, wherein the computer-executable instructions are configured to determine the current working environment by receiving a user's selection of one of a plurality of currently active working environments.

14. The computer program product of claim 12, wherein the computer-executable instructions are configured to determine the current working environment by determining a current working environment based on a working history list including currently and previously active working environments.

15. The computer program product of claim 14, wherein the computer-executable instructions are configured to determine the current working environment by selecting a most recent working environment from the currently active working environments in the working history list.

16. The computer program product of claim 12, wherein the computer-executable instructions are configured to receive the text in the first language by placing a transparent portion of the translation interface over the text.

17. The computer program product of claim 13, wherein the computer-executable instructions are configured to receive the user's selection of one of the currently active working environments by detecting the user clicking said one of the currently active working environments, and wherein the computer-executable instructions are configured to provide the translation of the text in the second language to the current working environment in response to said detection.
